(19) United States
(12) Patent Application Publication
(10) Pub. No.: US 2002/0125444 A1
(43) Pub. Date: Sep. 12, 2002

(54) Illumination-beam scanning configurations and methods for charged-particle-beam microlithography

(75) Inventor: Shinichi Kojima, Tokyo (JP)

Correspondence Address: KLARQUIST SPARKMAN, LLP, Suite 1600, One World Trade Center, 121 S.W. Salmon Street, Portland, OR, 97204-2988, US

(73) Assignee: Nikon Corporation

(21) Appl. No.: 10/052,866

(22) Filed: Jan. 17, 2002

(30) Foreign Application Priority Data
Jan. 17, 2001 (JP) 2001-008793

(51) Int. Cl. G21G 5/00

(52) U.S. Cl. 250/492.1

(57) ABSTRACT

Apparatus and methods are disclosed, in the context of charged-particle-beam microlithography, allowing increased illumination-beam current to shorten exposure time and provide good throughput, while decreasing aberrations from space-charge effects. The apparatus includes an illumination-optical system configured to shape the illumination beam to have a substantially annular transverse profile or a profile representing at least a portion of a substantially annular profile. The substantially annular profile is defined by respective concentric beam portions. The shaped illumination beam is scanned onto the reticle using a deflector in the illumination-optical system.

### FIELD

This disclosure pertains to microlithography performed using a charged particle beam such as an electron beam or ion beam. Microlithography is a key technique widely used in the fabrication of microelectronic devices such as integrated circuits, displays, thin-film magnetic pickup heads, and micromachines. More specifically, the disclosure pertains to charged-particle-beam microlithography apparatus and methods providing reduced space-charge effects while not compromising resolution or throughput.

### BACKGROUND

Conventional charged-particle-beam (CPB) microlithography systems are broadly classified into the following three types: (1) spot-beam exposure systems, (2) variably shaped beam exposure systems, and (3) block-exposure systems. These types of exposure systems provide better resolution than conventional optical-based batch-transfer systems, but exhibit lower throughput (number of wafers that can be processed per unit time). Throughput is especially limited with types (1) and (2), above, in which lithographic exposures are made by tracing the pattern on the substrate using a charged particle beam having an extremely small spot size (the “spot” being typically rectangular in profile). Block-exposure systems (type (3)) exhibit better throughput than either type (1) or type (2).

In block-exposure, certain portions (e.g., memory cells or the like that are repeated many times) of the pattern are defined on a mask and transferred to the wafer. Unfortunately, the number of pattern portions that can be defined and transferred in such a manner is limited. For example, non-repeated portions of the pattern must be transferred using a different technique such as the variably shaped beam exposure technique. Consequently, throughput is not improved as much as desired.

Considerable development effort currently is being expended to improve the throughput of CPB microlithography systems to levels not achievable with any of types (1)-(3), above. A promising approach is the so-called divided-reticle projection-transfer technique, in which a reticle defining the entire pattern for a complete “die” on the wafer is divided into multiple small exposure units, termed “subfields,” each defining a respective portion of the overall pattern. Each subfield is exposed in a respective exposure “shot.” Further details concerning this technique are set forth in U.S. Pat. No. 6,201,598.

Each exposure unit in a conventional block-exposure scheme is about 5 to 10 μm square on the wafer. In divided-reticle projection exposure, in contrast, the subfield is about 100 to 500 μm square on the wafer, which results in a correspondingly improved throughput obtained with divided-reticle projection exposure compared to block-exposure. (Typically, in divided-reticle pattern-transfer, the individual subfields are configured as large as possible while still controlling aberrations to acceptable levels.) Also, in the divided-reticle technique, because the entire reticle pattern is divided into subfields, there is no need to use another technique to expose pattern portions that are not extensively repeated. Consequently, throughput is further improved compared to the block-exposure technique.

The general principle of divided-reticle projection-exposure is shown in FIG. 9, depicting a portion of a reticle 100, a corresponding portion of a substrate (wafer) 110, and an optical axis Ax. The reticle 100 defines a pattern divided into a large number of exposure units (subfields) 100b each defining a respective portion of the pattern. The subfields 100b are arrayed in columns and rows and are separated from one another by struts 100c that strengthen and rigidify the reticle. As each subfield 100b is illuminated on the reticle, a portion of the illuminating charged particle beam (illumination beam IB) is transmitted through the illuminated subfield while acquiring an “aerial image” of the pattern portion defined by the illuminated subfield. The beam carrying the aerial image to the wafer 110 is thus termed the “patterned beam” PB. The patterned beam PB forms an actual image on the surface of the wafer 110 by a projection-optical system, not shown, situated between the reticle 100 and the wafer 110. In the scheme shown in FIG. 9, the subfields 100b are “transferred” one at a time to corresponding exposure regions 110b on the wafer 110. To expose the subfields 100b in each row in a sequential manner, the reticle 100 and wafer 110 are simultaneously continuously moved at respective prescribed velocities F_{M} and F_{W}. Note that the respective velocities F_{M}, F_{W} have opposite directions substantially along the Y-axis. Meanwhile, the illumination beam IB and patterned beam PB are deflected as required in respective (and opposite) X-axis directions to expose the subfields 100b in each row in a sequential manner to the respective exposure regions 100b on the wafer 110.

The subfield images are formed in the respective exposure regions 110b in a contiguous manner. I.e., the subfield images on the wafer do not include images of the struts 100c. Thus, the images of the respective pattern portions are “stitched” together to form an image of the complete pattern on the wafer 110.

In the divided-reticle scheme shown in FIG. 9, as described above, the subfields 100b are nominally square in shape, and each row of subfields contains many subfields with intervening struts 100c. The presence of so much strut structure requires that the reticle be very large. Also, during exposure, since each subfield 100b in each row is exposed individually, considerable exposure time is consumed simply in positioning each subfield and the charged particle beam properly for exposure. E.g., a certain amount of time is required for settling of the beam after being deflected from one subfield to the next. Also, after each subfield 100b is selected for exposure and just before exposing the respective subfield, beam position is determined. Since this settling and positioning and determination time (collectively termed “operational” time) is not actual exposure time, throughput is compromised.

Hence, to increase throughput of the divided-reticle scheme, it is necessary to reduce operational time as much as possible. To such end, a scheme that has attracted substantial attention is one in which the subfields in each row on the reticle are not separated from each other by struts. Rather, as shown in FIG. 10, the pattern on the reticle 100 is divided into multiple “deflection bands” 51A, 51B, 51C each having a length L corresponding to the length of a row of subfields in FIG. 6, and each separated from one another by intervening struts 52A. (In FIG. 10, only three deflection bands 51A, 51B, 51C are shown; it will be understood that normally the reticle defines many more deflection bands. The reticle 100 in FIG. 10 is termed a “slot-type” divided reticle.) Each deflection band in FIG. 10 is exposed by deflecting the illumination beam IB laterally (in the +X direction in the figure) in a continuous sweeping or scanning manner (note that the illumination beam IB has a square transverse profile). Thus, each deflection band typically has a length (in the X-axis direction in the figure) approximately equal to the width of the optical field of the CPB optical system. Meanwhile, the patterned beam PB is deflected laterally (in the −X direction in the figure) in a continuous sweeping manner. The respective velocity of such lateral scanning of the illumination beam IB and patterned beam PB is denoted D_{M} on the reticle 100 and D_{W} on the wafer 110, respectively. Meanwhile the reticle 100 is moved continuously in the +Y direction at a velocity F_{M}, and the wafer 110 is moved continuously in the −Y direction at a velocity F_{W}. Since each deflection band 51A, 51B, 51C is illuminated in one continuous scanning motion of the illumination beam IB, operational time required to expose each deflection band is less than required to expose a row of subfields in the scheme of FIG. 9. As a result, in the scheme of FIG. 10 throughput is improved and reticle size is reduced compared to the scheme of FIG. 9. In the reticle 100 of FIG. 10, since struts 52A are present between each deflection band 51A, 51B, 51C, exposure of successive deflection bands must be accompanied by adjustments of the patterned beam PB and wafer position sufficient not to form images of the struts 52A on the wafer 110.

During exposure of each deflection band 51A, 51B, 51C in FIG. 10 adjustments are made in real time to the illumination beam IB and patterned beam PB as required to reduce aberrations (e.g., distortion) and other detectable imaging faults (e.g., focus and magnification shifts). These adjustments are made continuously as exposure of a deflection band proceeds. Hence, operational time normally consumed in the FIG.-9 scheme in performing these adjustments on a subfield-by-subfield basis is eliminated, and each deflection band is exposed in a continuous manner. Consequently, pattern exposure can be performed with high resolution and at reasonably high throughput.

Further with respect to the schemes shown in FIG. 9 and FIG. 10, the beam-current density of the illumination beam IB is a factor influencing throughput. For example, the beam current can be increased to decrease exposure time, allowing the subfields or deflection bands to be exposed faster, which would increase throughput. Unfortunately, with either of these schemes, increasing beam-current tends to increase aberrations caused by space-charge effects that arise due to self-interactions of the charged particles in the beam. Space-charge effects tend to deteriorate the fidelity with which pattern elements are resolved on the wafer, and tend to degrade the accuracy with which pattern elements in adjacent subfield images or deflection-band images are stitched together on the wafer. Consequently, beam current conventionally must be limited, which imposes a ceiling over maximum achievable throughput.

### SUMMARY

In view of the shortcomings of conventional apparatus and methods as summarized above, the present invention provides, inter alia, charged-particle-beam (CPB) microlithography apparatus and methods that achieve higher throughput than conventional apparatus and methods while still maintaining high resolution.

According to a first aspect of the invention, CPB microlithographic-exposure apparatus are provided. An embodiment of such an apparatus comprises an illumination-optical system situated and configured to illuminate a selected region on a reticle, defining a pattern to be transferred to a sensitive substrate, with a charged-particle illumination beam. A portion of the illumination beam passing through the illuminated region of the reticle forms a patterned beam carrying an aerial image of the respective pattern portion defined in the illuminated region. The apparatus also includes a projection-optical system situated and configured to direct the patterned beam to a sensitive substrate and to form an image of the aerial image on the substrate. The illumination-optical system comprises a deflector situated and configured to scan the illumination beam in a lateral illumination-beam-scanning direction across the selected region of the reticle during exposure. The illumination-optical system also comprises a field-limiting diaphragm that comprises an aperture plate defining at least one aperture having a substantially annular profile or at least a portion of a substantially annular profile. Thus, the field-limiting aperture shapes the illumination beam, passing through the at least one aperture and being scanned by the deflector, into a hollow illumination beam having, as incident on the reticle, a substantially annular transverse profile or a portion of a substantially annular transverse profile.

By way of example, the field-limiting diaphragm defines at least one aperture having a chevron profile concentric with a beam-propagation axis of the illumination beam. E.g., the field-limiting diaphragm can define one such aperture or two chevron-shaped apertures facing each other and that are concentric with the beam-propagation axis of the illumination beam.

The deflector in the illumination-optical system desirably is configured to scan the illumination beam at a constant sweep velocity across the illuminated region.

The apparatus can further comprise a reticle stage and a substrate stage. The reticle stage is situated and configured for holding the reticle downstream of the illumination-optical system and for moving the reticle relative to the illumination-optical system. The substrate stage is situated and configured to hold the sensitive substrate downstream of the projection-optical system and for moving the substrate relative to the projection-optical system. The reticle stage and substrate stage can be configured to move the reticle and substrate, respectively, in respective stage-scanning directions that are substantially orthogonal to the illumination-beam-scanning direction.

The illumination-optical system can be further configured to provide the illumination beam with a distribution of beam intensity, immediately upstream of the reticle, that is constant over the region of the reticle illuminated by the illumination beam at any given instant in time.

The projection-optical system can further comprise a dynamic compensator situated and configured to impart a change to the patterned beam so as to compensate for aberrations of the image of the reticle pattern on the substrate surface. The dynamic compensator can be further configured to change the compensation applied thereby to the patterned beam, according to scanning of the illumination beam on the reticle by the deflector. The dynamic compensator desirably comprises at least one of a focus-compensation coil, a stigmator, and a deflector. In a more specific embodiment, the dynamic compensator comprises at least three focus-compensation coils, at least two stigmators, and at least one deflector.

The apparatus can further comprise an illumination compensator situated and configured to compensate for a change in profile of the illumination beam, as incident on the reticle, due to scanning of the illumination beam by the deflector. The illumination compensator can be further configured to change the compensation according to a change in scanning position of the illumination beam on the reticle as imparted by the deflector. The illumination compensator desirably comprises at least one component selected from the group consisting of focus-compensation coils and stigmators.

The illumination-optical system can be further configured to provide the illumination beam, as incident on the reticle, with an aperture-angle distribution ranging between a preselected minimum angle α_{ret, min} and a preselected maximum angle α_{ret, max}. If the charged particle beam is an electron beam, then the minimum angle α_{ret, min} and the maximum angle α_{ret, max} desirably each have a tolerance within a range of 1.5 to 3.0 mrad, and |α_{ret, max}−α_{ret, min}|≦0.75 mrad.

Another aspect of the invention is directed to methods for reducing aberrations caused by space-charge effects. These methods are set forth in the context of methods for performing CPB microlithography. In an embodiment of the aberration-reducing method, the illumination beam is scanned in a lateral illumination-beam-scanning direction across the selected region of the reticle during exposure of the reticle. Meanwhile, the illumination beam is passed through a field-limiting diaphragm situated in the illumination-optical system. The field-limiting diaphragm comprises an aperture plate defining at least one aperture having a substantially annular profile or at least a portion of a substantially annular profile. Thus, the field-limiting diaphragm shapes the illumination beam so as to form the illumination beam into a hollow illumination beam having, as incident on the reticle, a substantially annular transverse profile or a portion of a substantially annular transverse profile. The selected region on the reticle is illuminated with the hollow illumination beam.

In this method, the field-limiting diaphragm can define at least one aperture having a chevron profile concentric with a beam-propagation axis of the illumination beam. In this instance, the illumination beam is passed through the at least one aperture having a chevron profile. Alternatively, the field-limiting diaphragm can define two chevron-shaped apertures facing each other and that are concentric with the beam-propagation axis of the illumination beam. In this latter instance the illumination beam is passed through the two chevron-shaped apertures.

The method can further comprise the step of scanning, using the deflector in the illumination-optical system, the illumination beam at a constant sweep velocity across the illuminated region.

The method can further comprise the step of mounting the reticle on a reticle stage situated downstream of the illumination-optical system and configured for moving the reticle relative to the illumination-optical system. Also, the substrate is mounted on a substrate stage situated downstream of the projection-optical system and configured for moving the substrate relative to the projection-optical system. Using the reticle stage and substrate stage, the reticle and substrate, respectively, are moved in respective stage-scanning directions, that are substantially orthogonal to the illumination-beam-scanning direction, during exposure of the reticle pattern.

The method can further comprise the step of providing the illumination beam with a distribution of beam density, immediately upstream of the reticle, that is constant over the region of the reticle illuminated by the illumination beam at any given instant in time.

The method can further comprise the step of providing, using a dynamic compensator situated in the projection-optical system, a change to the patterned beam so as to compensate for aberrations of the image of the reticle pattern on the substrate surface. This embodiment can further comprise the step of changing the compensation applied by the dynamic compensator to the patterned beam, according to scanning of the illumination beam on the reticle by the deflector.

The method can further comprise the step of compensating for a change in profile of the illumination beam, as incident on the reticle, due to scanning of the illumination beam by the deflector. This embodiment can further comprise the step of changing the compensation according to a change in scanning position of the illumination beam on the reticle as imparted by the deflector.

The method can further comprise the step of providing the illumination beam, as incident on the reticle, with an aperture-angle distribution ranging between a preselected minimum angle α_{ret, min} and a preselected maximum angle α_{ret, max}. If the charged particle beam is an electron beam, then the minimum angle α_{ret, min} and the maximum angle α_{ret, max} each can have a tolerance within a range of 1.5 to 3.0 mrad, and |α_{ret, max}−α_{ret, min}|≦0.75 mrad.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic elevational view of a representative embodiment of a charged-particle-beam (CPB) microlithography apparatus.

FIG. 2 is an elevational optical diagram of the illumination- and projection-optical systems of the apparatus of FIG. 1.

FIG. 3(a) is a plan view of the aperture defined by a field-limiting diaphragm according to a first exemplary embodiment.

FIG. 3(b) is a plan view of the apertures defined by a field-limiting diaphragm according to a second exemplary embodiment.

FIG. 3(c) shows certain dimensional relationships of the apertures shown in FIG. 3(b).

FIG. 4(a) is a plan view of the aperture defined by an aperture-angle-limiting aperture according to a first exemplary embodiment.

FIG. 4(b) is a plan view of the aperture defined by an aperture-angle-limiting aperture according to a second exemplary embodiment.

FIG. 5 is an oblique view showing movements of the reticle, substrate, illumination beam, and patterned beam during exposure.

FIGS. 6(a)-6(b) depict certain details of step scanning of a deflection band.

FIG. 7 is a process flow chart depicting certain steps in a microelectronic-device manufacturing method.

FIG. 8 is a process flow chart depicting certain steps in a microlithography step of the method shown in FIG. 7.

FIG. 9 is an oblique view showing exposure of subfields of a segmented reticle as performed by a conventional CPB microlithography apparatus.

FIG. 10 is an oblique view showing exposure of deflection bands of a segmented reticle as performed by a conventional CPB microlithography apparatus.

### DETAILED DESCRIPTION

The invention is described below in the context of representative embodiments, which are not intended to be limiting in any way.

Certain descriptions below are in the context of using an electron beam as a representative charged particle beam. However, it will be understood that the principles disclosed herein are equally applicable to use of another type of charged particle beam, such as an ion beam.

Exposure Apparatus

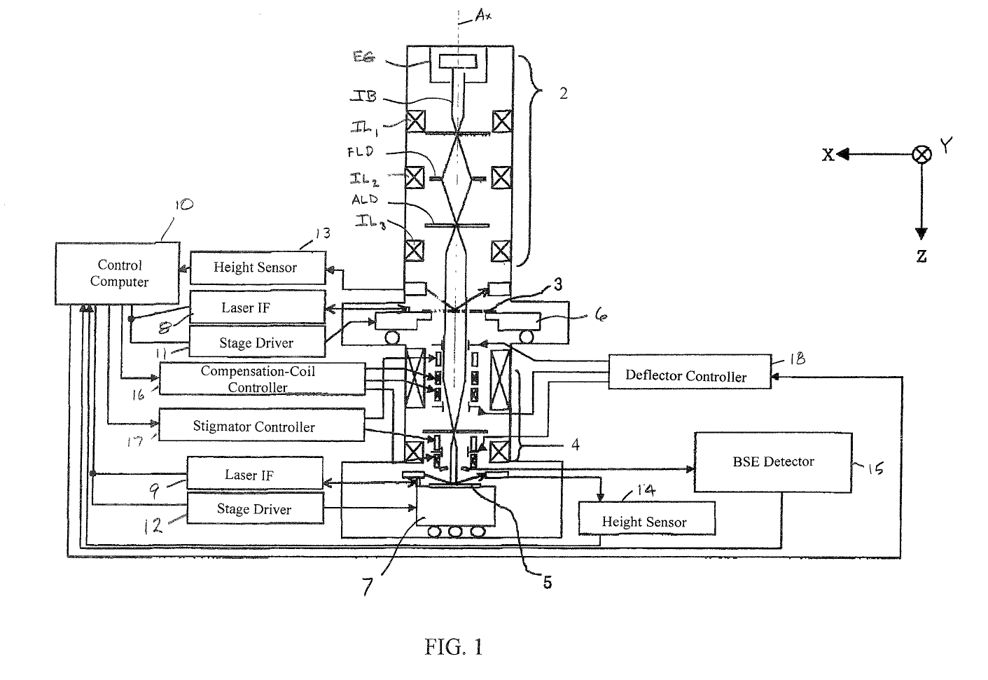

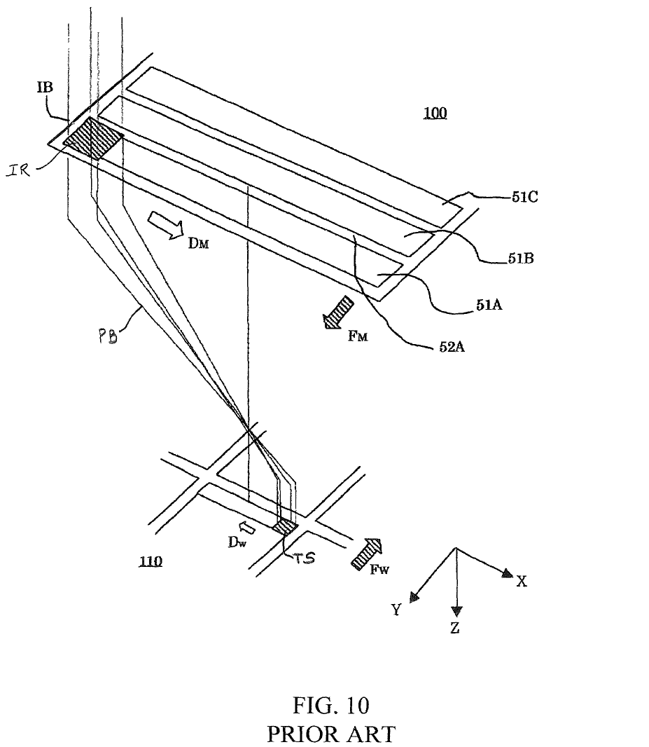

A representative embodiment of a charged-particle-beam (CPB) microlithography apparatus 1 (specifically an electron-beam microlithography apparatus) is shown in FIG. 1. The depicted apparatus is especially configured to utilize a slot-type reticle such as shown in FIG. 10. The depicted apparatus 1 comprises an illumination-optical system 2 situated and configured to direct an illumination beam IB onto a reticle 3 and a projection-optical system 4 situated downstream of the reticle 3. The projection-optical system 4 is configured to direct a patterned beam PB, carrying an aerial image of the region of the reticle 3 illuminated by the illumination beam IB, onto a corresponding location on the surface of a “sensitive” substrate 5. (A “sensitive” substrate has an upstream-facing surface coated with a suitable material, termed a “resist” that is imprintable with the aerial image when exposed by the patterned beam. A typical sensitive substrate is a resist-coated semiconductor wafer.)

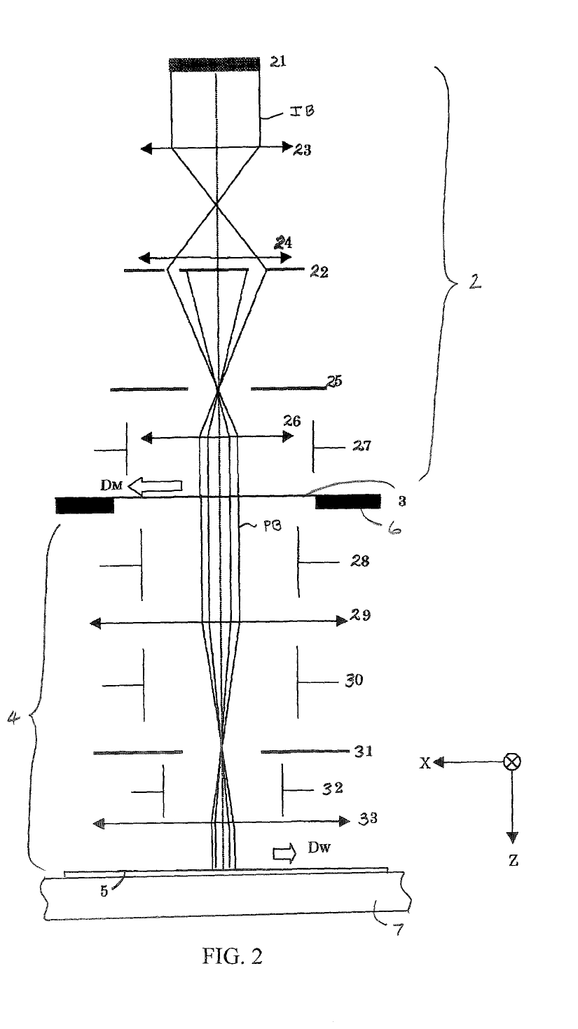

The illumination-optical system 2 (described later below) includes an electron gun EG, illumination lenses IL1, IL2, IL3, at least one deflector (not shown, but see FIG. 2), a field-limiting diaphragm FLD, and an aperture-angle-limiting diaphragm ALD. The electron gun EG desirably is configured to produce an illumination beam IB having a substantially uniform distribution of beam intensity especially as the beam is incident on the reticle 3.

The projection-optical system 4 (described later below) includes at least one projection lens, at least one deflector, a contrast diaphragm, and one or more compensatory components. An exemplary array of compensatory components includes at least two stigmators, at least three focus-compensation coils, and at least three deflectors.

The reticle 3 and substrate 5 are mounted on respective stages 6, 7 that are movable at least in respective X and Y directions. Respective positions of the stages are determined by respective laser interferometers (IFs) 8, 9 connected to a control computer 10. The control computer 10 controls the respective positions of the stages 6, 7, based on data routed to the control computer 10 from the respective laser IFs 8, 9, by actuating respective stage drivers 11, 12. The respective positions of the reticle 3 and substrate 5 along the optical axis Ax are detected by respective height sensors 13, 14, which also are connected to the control computer 10. Electrons backscattered from the surface of the substrate 5 are detected by a backscattered-electron (BSE) detector 15, which also is connected to the control computer 10.

The control computer 10 also is connected to a compensation-coil controller 16, a stigmator controller 17, and a deflector controller 18. The compensation-coil controller 16 is connected to the focus-compensation coils in the projection-optical system 4. The stigmator controller 17 is connected to the stigmators in the projection-optical system 4. The deflector controller 18 is connected to the deflectors in the projection-optical system 4.

Thus, the control computer 10 receives data from each of the height sensors 13, 14, each of the laser interferometers 8, 9, and the BSE detector 15. The control computer 10 routes respective control and actuation commands to each of the stage drivers 11, 12, the compensation-coil controller 16, the stigmator controller 17, and the deflector controller 18. The control computer 10 also routes appropriate commands to the various lenses and deflectors in the illumination-optical system 2 and the lenses in the projection-optical system 4.

Exemplary details of the illumination-optical system 2 and projection-optical system 4 are depicted in FIG. 2, in which the illumination-optical system 2 comprises an electron gun 21, a field-limiting diaphragm 22, illumination lenses 23, 24, 26, a deflector 27, and an aperture-angle-limiting diaphragm 25. The depicted projection-optical system 4 comprises deflectors 28, 30, 32, projection lenses 29, 33, and a contrast diaphragm 31.

Field-Limiting Diaphragm

In general, the illumination-optical system 2 is configured to provide the illumination beam IB with a substantially uniform intensity distribution for illuminating the reticle, while minimizing space-charge effects. Minimizing space-charge effects is achieved by shaping the illumination beam to have a “hollow” transverse profile. Providing the illumination beam with a hollow transverse profile causes the patterned beam to have a corresponding hollow transverse profile. A hollow transverse profile of the illumination beam is effective in establishing a substantially uniform distribution of illumination intensity throughout the region of the reticle illuminated at any given instant. Substantially uniform illumination intensity avoids so-called “illuminance non-uniformities,” which otherwise would cause problems of inconsistent pattern-element resolution and decreased controllability of linewidth of the pattern as projected onto the substrate.

For shaping the illumination beam IB in the manner summarized above, the field-limiting diaphragm 22 in the illumination-optical system 2 desirably defines one or more openings (apertures) configured to shape the illumination beam IB into a beam having a hollow transverse profile as the beam passes through the aperture(s). Hence, the field-limiting diaphragm 22 also is termed a “beam-shaping diaphragm.” More specifically, the field-limiting diaphragm 22 defines one or more apertures that provide the illumination beam IB, as the illumination beam passes through the aperture(s), with a substantially “annular” (“donut”) transverse profile or with a profile representing a portion of a substantially annular profile. Either general configuration of the illumination beam IB is representative of a “hollow” beam configuration.

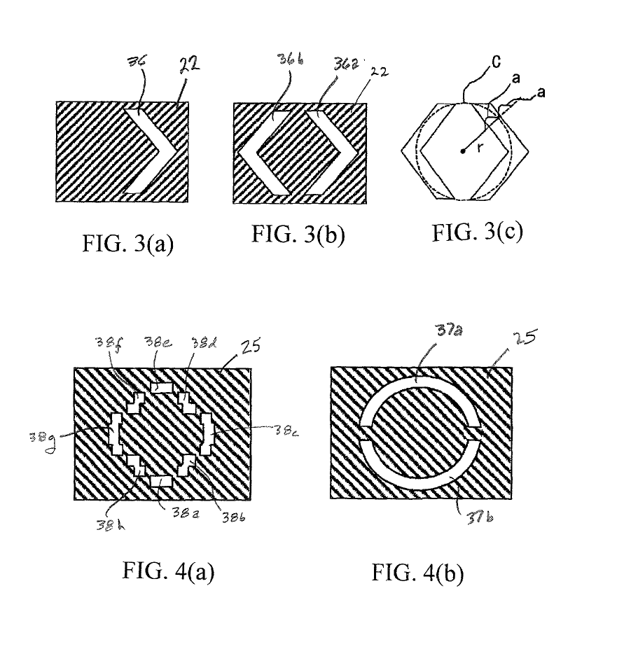

A first example embodiment of a field-limiting diaphragm 22 is shown in FIG. 3(a), defining a single “chevron”-shaped (“V”-shaped or wedge-shaped) aperture 36. FIG. 3(b) depicts a second example of a field-limiting diaphragm 22, which defines two opposing chevron-shaped aperture portions 36a, 36b. In either of these examples, the respective field-limiting diaphragm 22 configures the illumination beam IB with a substantially annular transverse profile (FIG. 3(b)) or with a portion of a substantially annular profile (FIG. 3(a)). Alternatively, for example, the field-limiting diaphragm 22 can define an aperture configured as a half-annulus or substantially full annulus (i.e., two concentric half-annuli facing each other). In other words, any of the various field-limiting diaphragms has at least one aperture 36 that defines a substantially annular aperture or a portion of a substantially annular aperture (a chevron or semicircular aperture is regarded as a “portion” of a substantially annular aperture). Each such aperture is concentric relative to the center (propagation axis) of the illumination beam. A substantially annular aperture is made up of aperture portions that are substantially concentric relative to the center of the beam. (E.g., the chevrons 36a, 36b collectively share a center located midway between them.)

Note that the example shown in FIG. 3(b) defines respective aperture portions that are separated from each other by segments of the diaphragm plate. These residual segments of the diaphragm plate provide physical support for the region of the diaphragm plate located inside the region enclosed by the two aperture portions 36a, 36b. Also, the field-limiting diaphragm of FIG. 3(b), similar to any field-limiting aperture defining a substantially annular aperture, provides about two times the illumination dose of the field-limiting diaphragm of FIG. 3(a) or any other field-limiting diaphragm defining essentially a half annulus. Hence, exposure can be performed using the field-limiting diaphragm of FIG. 3(b) at a speed that is about double the speed of an exposure performed using the field-limiting diaphragm of FIG. 3(a).

In general, in a subfield or other region being exposed at a given instant of time, aberration at a particular locus in the region resulting from a space-charge effect is a function of distance of the locus from the center of the region (i.e., distance of the locus from the center of the illumination beam). By passing the illumination beam through a field-limiting diaphragm as described above, illumination of the region is performed with a predetermined approximately constant amount of aberration over the illuminated region. A constant aberration is desirable because it allows easy dynamic compensation for the aberration over the entire exposed region, as discussed later below. “Dynamic” compensation is performed in real time during actual exposure of the region. By dynamically compensating for the predetermined constant aberration, any net (residual) aberration can be reduced substantially to zero within the exposed region during exposure of the region.

Passing the illumination beam through a field-limiting diaphragm as described above also substantially reduces the space-charge effect, which allows microlithographic transfer to be performed at higher resolution and lower distortion compared to conventional CPB microlithography systems, even at elevated illumination-beam current.

Scanning Exposure

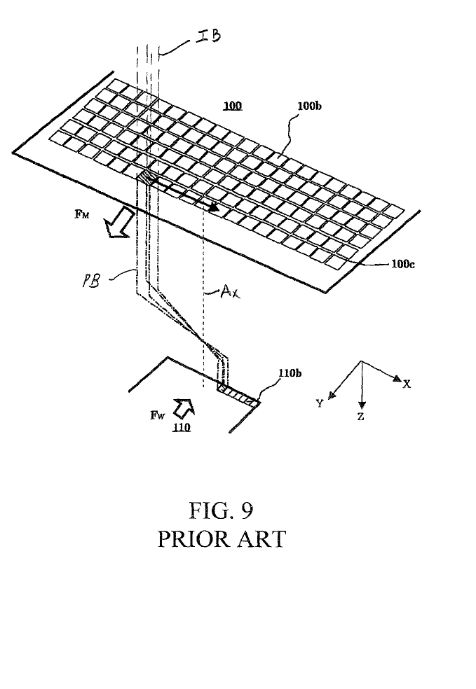

A shaped illumination beam as described above desirably is scanned over a deflection band (FIG. 10) at a constant scanning velocity. A constant scanning velocity of the illumination beam facilitates the achievement of exactly the same amount of illumination at all regions of the deflection band (including all regions containing pattern elements), as well as all deflection bands on the reticle. This uniformity of illumination also facilitates obtaining a substantially constant pattern-element resolution throughout the entire pattern as transferred to the substrate. In addition, the scanning exposure achieves higher throughput than a step-and-repeat exposure. However, especially if a lower throughput can be accommodated, it will be appreciated that exposure alternatively can be performed in a step-and-repeat manner from subfield-to-subfield (FIG. 9) using a shaped beam.

During scanning exposure the illumination beam IB and patterned beam PB are laterally deflected as required (e.g., in the +X and −X directions, respectively) by respective deflectors in the illumination-optical system and projection-optical system, respectively. Meanwhile, the reticle stage 6 and substrate stage 7 physically move the reticle 3 and substrate 5, respectively, in directions substantially perpendicular (e.g., in the +Y and −Y directions, respectively) to the beam-deflection directions. I.e., these beam-deflection and stage-movement directions are substantially orthogonal to each other.

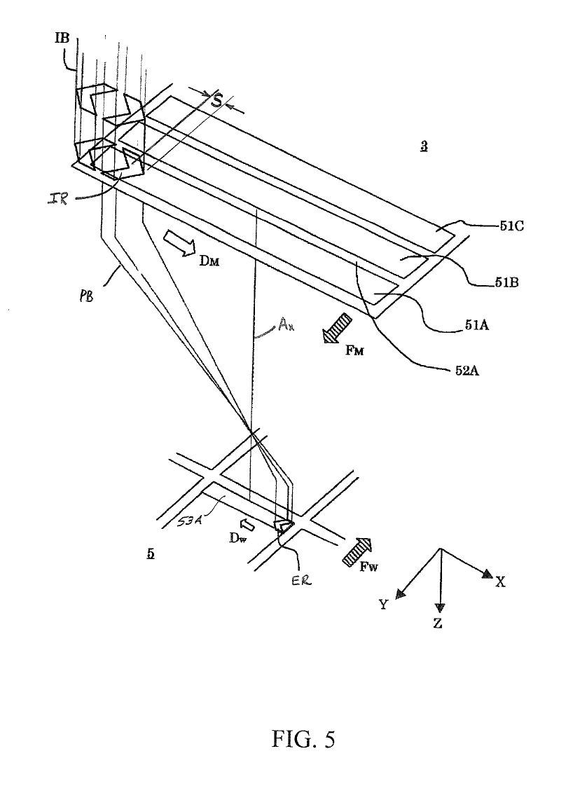

FIG. 5 depicts scanning exposure using an illumination beam shaped by passage through the substantially annular aperture of FIG. 3(b). FIG. 5 is similar in many respects to FIG. 10 except for the transverse profile of the illumination beam IB and patterned beam PB. In FIG. 5, the components of the illumination-optical and projection-optical systems are not shown for clarity. As can be seen in FIG. 5, the illumination beam IB illuminating the reticle 3 has two portions each having a respective chevron-shaped transverse section. The chevrons face each other as shown and collectively define a substantially annular aperture that is concentric with the center of the beam.

The illumination beam IB is scanned at a constant respective velocity over a deflection band 51A of the reticle 3 in the direction DM (+X direction in the figure) by means of the deflector 27 in the illumination-optical system 2 (FIG. 2). Meanwhile, the patterned beam PB downstream of the reticle 3 is projected onto the substrate (wafer) 5 by means of the projection lenses 29, 33 in the projection-optical system 4 (FIG. 2). The patterned beam PB is scanned at a constant respective velocity over a respective band 53A on the substrate 5. The patterned beam PB is scanned in the direction D_{W} (−X direction). Hence, the respective scanning directions D_{M} and D_{W} of the illumination beam IB and patterned beam PB, respectively, are opposite each other. The scanning velocity of the patterned beam PB (on the substrate) relative to the scanning velocity of the illumination beam IB (on the reticle) is substantially equal to the “demagnification ratio” of the projection lenses 29, 33.

Meanwhile, the reticle 3 and substrate 5 are moved by their respective stages 6, 7 in opposite directions (arrows F_{M} and F_{W} in the +Y and −Y directions, respectively, in the figure) at constant respective velocities as exposure progresses from one deflection band to the next. The ratio of the substrate-motion velocity to the reticle-motion velocity is slightly different from the demagnification ratio (i.e., the velocity of the reticle 3 is slightly greater than what it ordinarily would be if the velocity ratio were equal to the demagnification ratio) for reasons as discussed in U.S. Pat. No. 5,879,842. The Y-direction position, relative to the reticle, of the illumination beam IB varies according to the movement of the reticle 3. For this reason, the illumination beam IB is deflected by the deflector 27 (FIG. 2) as required to follow the movement of the reticle 3. Thus, the Y-direction position of the illumination beam IB, relative to the reticle 3, does not change during illumination of a deflection band. In addition, the deflector 32 (FIG. 2) is used to deflect the patterned beam PB as required to prevent transfer of images of the struts 52A to the substrate 5.

Continuous movements of the reticle 3 and substrate 5, as discussed above, during exposure are advantageous. In an exposure scheme in which the reticle stage 6 and substrate stage 7 are stopped during transfer of each subfield (FIG. 9), the stages must accelerate to move to the next subfield and decelerate when the next subfield is reached. This acceleration and deceleration occurs between each subfield, which consumes overall exposure time because it is not possible to perform exposure during accelerations and decelerations of the stages. By exposing deflection bands in a scanning manner (FIG. 5) with the reticle stage 6 and substrate stage 7 moving at respective continuous stage velocities, a substantial amount of time is not consumed in accelerations and decelerations of the stages, and exposures can be performed largely without interruption.

Passing the illumination beam IB through a field-limiting diaphragm as described above provides an advantage in scanning exposure. The resulting hollow-beam profile of the illumination beam IB provides a substantially uniform distribution of illumination intensity (illumination “density”) just upstream of the reticle 3 at any instant in time. The substantially uniform intensity distribution extends over the entire region on the reticle 3 illuminated at any given instant (including in directions orthogonal to the scanning direction).

In other words, to avoid the problem of inconsistent pattern-element resolution and decreased controllability of linewidth of the pattern as projected onto the substrate, the accumulated dose in the resist should be constant. To obtain this constant dose, the following equation desirably is satisfied:

∫ρ(x,y)dx=constant (1)

wherein ρ(x,y) is the distribution of illumination density just upstream of the reticle, and the scanning direction is the X direction. For satisfying this equation, the shape of the illumination beam and the distribution of the illumination-beam intensity are significant parameters. Consequently, the distribution of the illumination beam should be determined according to the shape of the illumination beam as incident on the reticle.

In actual practice, controllably changing the intensity distribution of the illumination beam can be difficult. Hence, in general, the intensity distribution of the illumination beam immediately upstream of the reticle is kept constant by passing the illumination beam through a field-limiting aperture as described above, not only in the scanning direction but also in other directions (including the direction orthogonal to the scanning direction). To such end, referring to FIG. 5, the width S of the region IR in the X direction is constant at any location (in the region IR) in the Y direction (orthogonal to the X scanning direction). If the width S is not constant, then the distribution of illumination intensity should change accordingly to satisfy Equation (1), above. In any event, by following the principles set forth above, illumination non-uniformities on the reticle are avoided, which improves the uniformity of resolution and linewidth of the pattern as exposed on the substrate.

In addition to or as an alternative to using a field-limiting aperture as described above, controllably changing the distribution of illumination intensity (at the reticle) of the illumination beam can be achieved using, e.g., an astigmatic compensator (stigmator) and/or a deflector in the illumination-optical system. However, using a field-limiting diaphragm in the manner described above is much simpler and yields more consistent results.

Dynamic Aberration Compensation

Scanning of the illumination beam IB along a region (deflection band) on the reticle 3 is performed using a deflector (e.g., the deflector 27 in FIG. 2) in the illumination-optical system 2. As the illumination beam scans a region (deflection band) on the reticle 3, the patterned beam PB scans a corresponding location on the surface of the substrate 5. Such scanning of the illumination beam IB over the reticle 3 can generate “deflection aberrations” (e.g., distortion and/or blur) in the transfer images as formed on the substrate 5. The magnitude of these aberrations tends to increase with corresponding increases in the distance between the illumination beam IB and the optical axis Ax.

It is desired that dynamic aberration compensations be performed whenever the deflection aberration exceeds a pre-set tolerance. In general, dynamic compensation is performed using at least one dynamic compensator, located in the projection-optical system 4, selected from a group consisting of focus-compensation coils, astigmatic compensators (stigmators), and deflectors. In a more specific embodiment the dynamic compensator in the projection-optical system 4 includes at least three focus-compensation coils, at least two stigmators, and at least one fine-positioning deflector. This combination of components can achieve real-time adjustments, as required, of parameters such as image focus, image rotation, image magnification, astigmatic orthogonal distortion, anisotropic magnification distortion, astigmatism, and image position on the image plane of the substrate. These adjustments can be made independently.

Alternatively or in addition to employing a dynamic compensator in the projection-optical system, a dynamic compensator can be provided in the illumination-optical system 2. The profile of the illumination beam IB on the reticle changes as a function of deflection angle of the illumination beam. These changes are also deflection aberrations. The dynamic compensator in the illumination-optical system is used to restore the profile of the illumination beam IB on the surface of the reticle 3, thereby correcting the deflection aberrations. I.e., small changes in the transverse profile of the illumination beam IB on the reticle 3 are made as required to ensure that all portions of each deflection band receives an illumination beam that is substantially free of deflection aberrations.

Dynamic compensation can be activated whenever the distance of deflection exceeds a pre-determined threshold limit within which the profile and intensity of illumination can be uniform. Thus, substantially uniform illumination profile and intensity can be achieved over the entire deflection range at the reticle 3. A dynamic compensator in the illumination-optical system 2 generally comprises at least one focus-compensation coil and/or at least one stigmator. The focus-compensation coil provides compensation of image magnification, rotation, and focus. The stigmator provides compensation of astigmatism, orthogonality, and anisotropic magnification distortion of the image. In this regard, reference is made to U.S. Pat. No. 6,087,669, incorporated herein by reference.

Since the illumination beam IB is continuously scanned, it is desirable that aberrations of the reticle image, as formed on the substrate 5, be compensated for in real time. Compensations as described above typically are performed based on data that has been obtained, directly or by calculation, in advance of the exposure. Consequently, in actual practice, it is very difficult to provide, on a continuous and instantaneous basis, the data necessary for performing compensations. Instead, the data typically is obtained or calculated incrementally for each of multiple preselected deflection positions, and compensation data are updated whenever the beam assumes one of the preselected deflection positions. In such instances, the increments between the preselected deflection positions can be made sufficiently small to allow compensations to be calculated and performed that adequately approximate continuous real-time compensations. Thus, adequate compensation accuracy is obtained.

Incidence-Angle Distribution of the Illumination Beam

As discussed above, the illumination beam IB is shaped by the field-limiting diaphragm 22 such that the integral of illumination intensity (density) over the full transverse area of the beam, in the X direction and Y direction, as incident on the reticle is substantially constant. As a result, illumination intensity at the various pattern elements on the reticle is substantially constant. As noted above, for achieving such ends the field-limiting diaphragm can define any of variously shaped openings that achieve a hollow illumination beam. For example, the opening may be configured as a single chevron as shown in FIG. 3(a). From the standpoint of achieving higher throughput, it is desirable that the illumination beam have a large transverse area (e.g., by passing through the apertures 36a, 36b shown in FIG. 3(b)). However, if the area is too large, then aberrations attributable to the space-charge effect are not constant over the entire illuminated region.

At a particular locus in an illuminated region, the level of aberration attributable to the space-charge effect is a function of distance of the locus from the center of the illumination beam. As shown in FIG. 3(c), a circle C having a radius r from the center of the illumination beam can be defined relative to the transverse profile of the hollow illumination beam (in this instance the illumination beam passed through a field-limiting diaphragm as shown in FIG. 3(b)). The indicated zones “a” are located in a particular range, along the radius “r” of the circle C, at which the aberration due to the space-charge effect is considered as fixed. Desirably, the field-limiting diaphragm shapes the illumination beam to have a transverse profile within the zones a.

In FIG. 3(c), note that the circle C (shown by dashed line) is configured such that its circumference is in the middle of the zones a. I.e., the portion of the zone a located inside the circle C is equal to the portion of the zone outside the circle. Alternatively, these distances inside and outside the circle can be different, depending upon the specific profile of aberration due to the space-charge effect.

In the apparatus in FIG. 2, the angular distribution of the illumination beam IB incident to the reticle 3 is limited by the aperture-angle-limiting diaphragm 25, which facilitates further reduction of aberrations attributable to the space-charge effect. Exemplary aperture-angle-limiting diaphragms are shown in FIGS. 4(a) and 4(b). In FIG. 4(b), two opposing semicircular aperture portions 37a, 37b are defined that collectively form a substantially annular aperture. In FIG. 4(a), multiple aperture portions 38a-38h are defined that collectively form a substantially annular aperture.

In general, the distribution of the aperture angle of the illumination beam IB incident to the reticle 3 desirably extends between a minimum angle and a maximum angle. Each of these angles has a respective tolerance. By maintaining these angles of the illumination beam within the specified tolerances, the distribution of charged particles in the patterned beam has a desired substantially annular profile sufficient for adequately increasing the mean distance between charged particles of the beam. Consequently, the space-charge effect is further reduced.

By way of example, if the illumination beam is an electron beam, then the minimum angle and maximum angle, relative to the optical axis Ax, each have a tolerance of 1.5 mrad to 3 mrad. I.e., the minimum angle α_{ret, min} of the illumination beam IB as incident on the reticle 3 has a tolerance of 1.5 mrad to 3 mrad, and the maximum angle α_{ret, max} of the illumination beam IB as incident on the reticle 3 also has a tolerance of 1.5 mrad to 3 mrad. Furthermore, the minimum and maximum angles desirably satisfy the relationship |α_{ret, max}−α_{ret, min}|≦0.75 mrad. If the minimum angle α_{ret, min} were less than 1.5 mrad, then achieving a target pattern-element resolution on the substrate 5 would be excessively difficult. This is because, at α_{ret, min}<1.5 mrad, the influence of the central portion of the beam is excessive, which decreases the benefit of a hollow beam and increases blur caused by the space-charge effect. If the minimum angle α_{ret, min} were greater than 3 mrad, then geometric aberrations of the projection-optical system 4 would be excessively large (despite limited Coulomb effects), which would make achieving a target resolution of 90 nm excessively difficult. If the maximum angle α_{ret, max} were less than 1.5 mrad, then a target resolution of 90 nm would be excessively difficult to achieve. This is because, under such conditions, the maximum value of the angular distribution of the illumination beam is too small, the diameter of the illumination beam in the vicinity of the field-limiting diaphragm is too small, and blur due to random scattering caused by Coulomb effects is excessively increased. If the maximum angle α_{ret, max} were greater than 3 mrad, then if geometric aberrations of the projection-optical system should become large and the Coulomb effect should be limited, geometric aberrations nevertheless would be large. Hence, it would be difficult to achieve a target resolution of 90 nm.

As noted above, |α_{ret, max}−α_{ret, min}|≦0.75 mrad. If |α_{ret, max}−α_{ret, min}| were greater than 0.75 mrad, then the substantially annular illumination region would be too wide. This would reduce the effectiveness of the annular-illumination effect, resulting in blur due to the space-charge effect. This would make it difficult to achieve a target resolution of 90 nm.

By restricting the minimum angle α_{ret, min}, the maximum angle α_{ret, max}, and the difference |α_{ret, max}−α_{ret, min}| as noted above, the Coulomb effect and the space-charge effect are reduced most effectively, which provides satisfactory reduction of geometric aberrations caused by lateral beam deflection.

Step Scanning

In CPB microlithography apparatus of recent vintage, the illumination-optical system and projection-optical system each have multiple deflectors. The deflectors are used for various purposes such as deflection of the beam and compensation for aberrations. The sizes of these deflectors can vary for various reasons, resulting in use of variously sized drivers and/or drivers having different inductances. As a result, the transition time of the respective deflectors (i.e., the time required after onset or change of energization for the output of the deflector to stabilize) may vary from one deflector to the next. Theoretically, it is possible to equalize transition times of multiple deflectors by making the driver inductances of the deflectors equal to each other. However, this is not always practical.

It is necessary to continuously change the outputs of the various deflectors when performing continuous beam scanning. Under such conditions, due to the different transition times of the respective deflectors, beam position may not be stable. Whenever beam-position instability is a problem, step-scanning can be employed. For example, step-scanning can be when calibrating the CPB optical system.

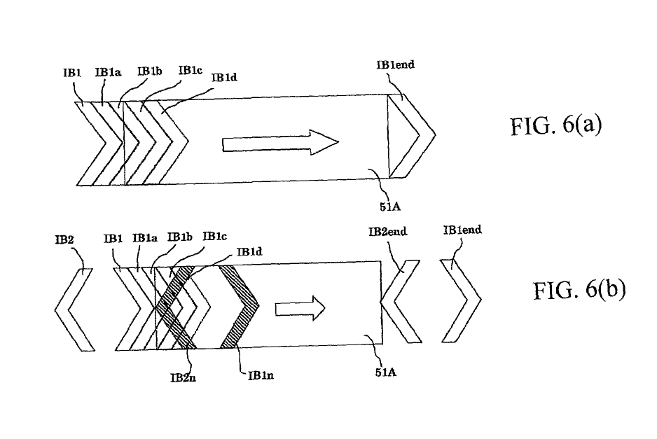

FIGS. 6(a)-6(b) depict an example of step scanning of a deflection band 51A. In FIG. 6(a), the hollow illumination beam IB as incident on the reticle has a single chevron profile IB1. In FIG. 6(b), the illumination beam IB as incident on the reticle has a double-chevron profile IB1, IB2. Step-scanning of the beam is performed using deflectors. In FIGS. 6(a)-6(b), to facilitate explanation, the width of the illumination beam IB in the top-to-bottom direction on the page is equal to the width of the deflection band 51A. However, it will be understood that the width of the illumination beam IB may be greater than the width of the deflection band if positional stability of the illumination beam in the top-to-bottom direction becomes a problem.

In FIG. 6(a), the illumination beam IB1 is step-scanned in the sequence IB1a, IB1b, IB1c, IB1d in the direction indicated by the arrow. Step-scan exposure is continued in this manner to IB1_{end}. The pattern elements projected onto the substrate in the respective steps are stitched together on the substrate. All the deflection bands 51A are transferred in this manner to the substrate.

In FIG. 6(b), the illumination beam IB1 is step-scanned in the sequence IB1a, IB1b, IB1c, IB1d in the direction indicated by the arrow. (The illumination beam IB2 is similarly step-scanned.) Step-scan exposure is continued in this manner to IB1_{end} and IB2_{end}, respectively. Note that, to facilitate explanation, the tracks of the steps are not shown for the illumination beam IB2. Compared to FIG. 6(a), since two illumination beams IB1, IB2 are used in the scheme of FIG. 6(b), throughput is improved because the exposure energy eventually received at any location on the substrate is essentially twice the energy received on the substrate in the scheme of FIG. 6(a). However, in the scheme shown in FIG. 6(b), if beam deflection is not performed with high precision (e.g., if a slight gap has been opened between exposed regions IB1a and IB1b), then exposure defects could occur. It is possible to expose any such gap using the opposing illumination beam IB2. Such a situation is shown in FIG. 6(b), in which the region IB2n exposed by the illumination beam is depicted overlapping the regions IB1a-IB1d exposed by the illumination beam IB1.

In step-scanning exposure as described above, it is possible to perform aberration compensation with better accuracy and precision by varying the energization parameters of the focus coil and the stigmator (exemplary dynamic compensators) between respective exposure steps. Note that dynamic compensators also require transition time. But, from the standpoint of time required to complete exposure, it is preferable that the variable condensers and resistors of the drivers that drive the compensators be adjusted as required to perform their respective compensations within a time period that is shorter than the deflector transition time.

Microelectronic-Device Fabrication Methods

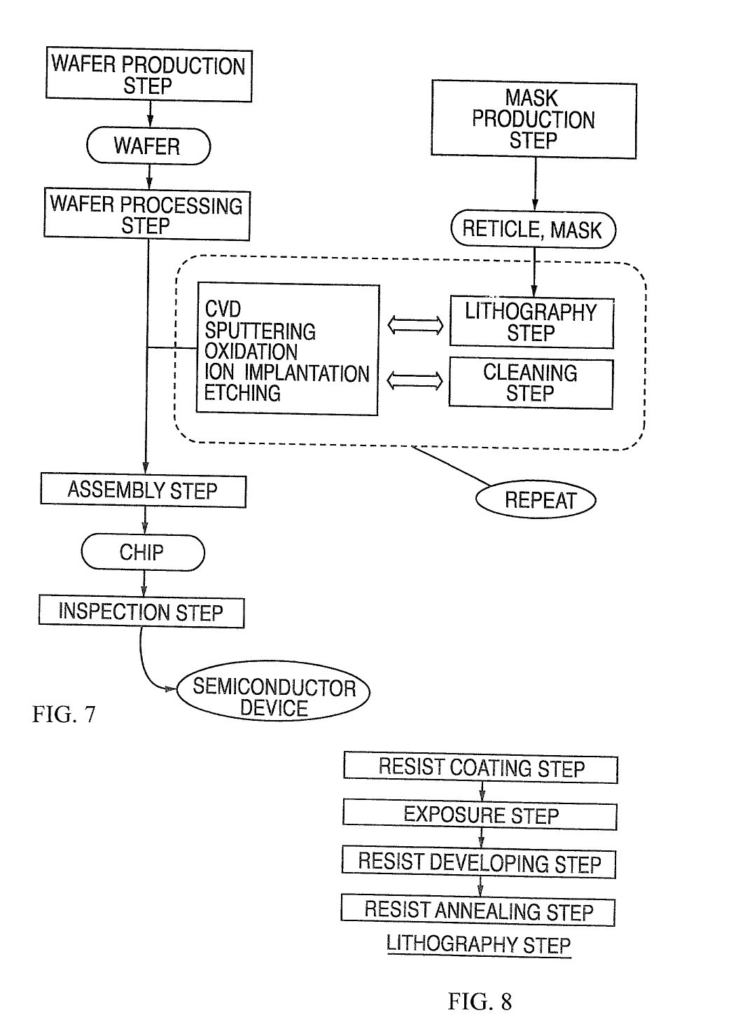

FIG. 7 is a flowchart of an exemplary microelectronic-device fabrication method to which apparatus and methods according to the invention can be applied readily. The fabrication method generally comprises the main steps of wafer production (wafer preparation), wafer processing, device assembly, and device inspection. Each step usually comprises several sub-steps.

Among the main steps, wafer processing is key to achieving the smallest feature sizes (critical dimensions) and best inter-layer registration. In the wafer-processing step, multiple circuit patterns are successively layered atop one another on the wafer, forming multiple chips destined to be memory chips or main processing units (MPUs), for example. The formation of each layer typically involves multiple sub-steps. Usually, many operative microelectronic devices are produced on each wafer.

Typical wafer-processing steps include: (1) thin-film formation (by, e.g., sputtering or CVD) involving formation of a dielectric layer for electrical insulation or a metal layer for connecting wires or electrodes; (2) oxidation step to oxidize the substrate or the thin-film layer previously formed; (3) microlithography to form a resist pattern for selective processing of the thin film or the substrate itself; (4) etching or analogous step (e.g., dry etching) to etch the thin film or substrate according to the resist pattern; (5) doping as required to implant ions or impurities into the thin film or substrate according to the resist pattern; (6) resist stripping to remove the remaining resist from the wafer; and (7) wafer inspection. Wafer processing is repeated as required (typically many times) to fabricate the desired semiconductor chips on the wafer.

FIG. 8 provides a flow chart of typical steps performed in microlithography, which is a principal step in wafer processing. The microlithography step typically includes: (1) resist-application step, wherein a suitable resist is coated on the wafer substrate (which can include a circuit element formed in a previous wafer-processing step); (2) exposure step, to expose the resist with the desired pattern; (3) development step, to develop the exposed resist to produce the imprinted image; and (4) optional resist-annealing step, to enhance the durability of the resist pattern.

The process steps summarized above are all well known and are not described further herein.

In the microlithography step (FIG. 8), performing exposures using a shaped beam as described above provides improved accuracy and precision of microlithographic exposure. For example, smaller linewidths and better layering accuracy can be achieved, compared to results obtained using conventional CPB microlithography apparatus.

### EXAMPLES

The following Examples 1 and 2 were performed using an illumination beam shaped by passage through a field-limiting diaphragm such as shown in FIG. 3(b). Hence, the patterned beam reaching the substrate surface also had a profile as shown in FIG. 3(b). The following Comparison Example was performed using a conventionally configured illumination beam. In all three instances, the beam current reaching the substrate was 20 μA. A stencil reticle was used, with the aperture ratio of the reticle pattern being 50% (25% for complementary reticles). Hence, the beam current on the reticle was 80 μA. The demagnification ratio was ¼.

### Example 1

The axial distance between the reticle and sensitive substrate was 500 mm, and the beam-acceleration voltage was 100 keV. The Gaussian distribution in which the electron-beam aperture half angle was 9 mrad on the substrate was a distribution that was cut off at α_{sub, max}=9 mrad. Of the transfer image, blur resulting from the space-charge effect, as well as internal distortion, are listed in Table 1, below.

### Example 2

The axial distance between the reticle and sensitive substrate was 500 mm, and the beam-acceleration voltage was 100 keV. The Gaussian distribution in which the electron-beam aperture half angle was 9 mrad on the substrate was a distribution that was cut off between α_{sub, min}=7 mrad and α_{sub, max}=9 mrad. Of the transfer image, blur resulting from the space-charge effect, as well as internal distortion, are listed in Table 1, below.

### Comparison Example (CE)

The axial distance between the reticle and sensitive substrate was 500 mm, and the beam-acceleration voltage was 100 keV. The Gaussian distribution in which the electron-beam aperture half angle was 9 mrad on the substrate was a distribution that was cut off at α_{sub, max}=9 mrad. The transverse profile of the beam on the substrate surface had dimensions of 150 μm square. Of the transfer image, blur resulting from the space-charge effect, as well as internal distortion, are listed in Table 1, below.

TABLE 1

| | Max Blur within | Distortion of |
|---|---|---|
| Example | Transfer Image | Transfer Image |
| 1 | 55 nm | 4 nm |
| 2 | 53 nm | 3 nm |
| CE | 80 nm | 16 nm |

From the data in Table 1, it can be seen that Example 1 exhibited an internal distortion, at the same beam current, that was ¼ the internal distortion exhibited by the Comparison Example (CE). Example 1 also exhibited a substantially reduced blur compared to the Comparison Example. In Example 2 substantially annular illumination (wherein the aperture angle distribution was limited by an aperture such as shown in FIG. 4(b) was combined with the other parameters of Example 1, resulting in an internal distortion of about ⅕ that of the Comparison Example. Blur also is further reduced. The blur and distortion data in Examples 1 and 2 were obtained after compensating for image rotation, magnification, focus, astigmatism, orthogonality, anisotropic distortion, and deflection position.

Therefore, as indicated by the data obtained with Examples 1 and 2, compared to the Comparison Example, shaping the illumination beam as described above substantially reduced degradations of pattern-element resolution resulting from the space-charge effect, substantially reduced image distortion resulting from the space-charge effect, and substantially reduced positional misalignments of pattern elements. These benefits can be achieved at elevated beam current and while performing continuous transfer of deflection bands of a segmented reticle, using a beam having a hollow transverse profile shaped by passage through an aperture having a substantially annular profile or a portion of a substantially annular profile.

Whereas the invention has been described in connection with representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A charged-particle-beam (CPB) microlithographic-exposure apparatus, comprising:
an illumination-optical system situated and configured to illuminate a selected region on a reticle, defining a pattern to be transferred to a sensitive substrate, with a charged-particle illumination beam, wherein a portion of the illumination beam passing through the illuminated region of the reticle forms a patterned beam carrying an aerial image of the respective pattern portion defined in the illuminated region; and
a projection-optical system situated and configured to direct the patterned beam to a sensitive substrate and to form an image of the aerial image on the substrate,
wherein the illumination-optical system comprises (a) a deflector situated and configured to scan the illumination beam in a lateral illumination-beam-scanning direction across the selected region of the reticle during exposure, and (b) a field-limiting diaphragm comprising an aperture plate defining at least one aperture having a substantially annular profile or at least a portion of a substantially annular profile that shapes the illumination beam, passing through the at least one aperture and being scanned by the deflector, into a hollow illumination beam having, as incident on the reticle, a substantially annular transverse profile or a portion of a substantially annular transverse profile.

2. The apparatus of claim 1, wherein the field-limiting diaphragm defines at least one aperture having a chevron profile concentric with a beam-propagation axis of the illumination beam.

3. The apparatus of claim 2, wherein the field-limiting diaphragm defines two chevron-shaped apertures facing each other and that are concentric with the beam-propagation axis of the illumination beam.

4. The apparatus of claim 1, wherein the deflector in the illumination-optical system is configured to scan the illumination beam at a constant sweep velocity across the illuminated region.

5. The apparatus of claim 1, further comprising:
a reticle stage situated and configured for holding the reticle downstream of the illumination-optical system and for moving the reticle relative to the illumination-optical system; and
a substrate stage situated and configured to hold the sensitive substrate downstream of the projection-optical system and for moving the substrate relative to the projection-optical system.

6. The apparatus of claim 5, wherein the reticle stage and substrate stage are configured to move the reticle and substrate, respectively, in respective stage-scanning directions that are substantially orthogonal to the illumination-beam-scanning direction.

7. The apparatus of claim 1, wherein illumination-optical system is further configured to provide the illumination beam with a distribution of beam intensity, immediately upstream of the reticle, that is constant over the region of the reticle illuminated by the illumination beam at any given instant in time.

8. The apparatus of claim 1, wherein the projection-optical system further comprises a dynamic compensator situated and configured to impart a change to the patterned beam so as to compensate for aberrations of the image of the reticle pattern on the substrate surface.

9. The apparatus of claim 8, wherein the dynamic compensator is further configured to change the compensation applied thereby to the patterned beam, according to scanning of the illumination beam on the reticle by the deflector.

10. The apparatus of claim 8, wherein the dynamic compensator comprises at least one of a focus-compensation coil, a stigmator, and a deflector.

11. The apparatus of claim 10, wherein the dynamic compensator comprises at least three focus-compensation coils, at least two stigmators, and at least one deflector.

12. The apparatus of claim 1, further comprising an illumination compensator situated and configured to compensate for a change in profile of the illumination beam, as incident on the reticle, due to scanning of the illumination beam by the deflector.

13. The apparatus of claim 12, wherein the illumination compensator is further configured to change the compensation according to a change in scanning position of the illumination beam on the reticle as imparted by the deflector.

14. The apparatus of claim 12, wherein the illumination compensator comprises at least one component selected from the group consisting of focus-compensation coils and stigmators.

15. The apparatus of claim 1, wherein the illumination-optical system is further configured to provide the illumination beam, as incident on the reticle, with an aperture-angle distribution ranging between a preselected minimum angle α_{ret, min} and a preselected maximum angle α_{ret, max}.

16. The apparatus of claim 15, wherein:
the charged particle beam is an electron beam; and
the minimum angle α_{ret, min} and the maximum angle α_{ret, max} each have a tolerance within a range of 1.5 to 3.0 mrad, and |α_{ret, max}−α_{ret, min}|≦0.75 mrad.

17. In a method for performing charged-particle-beam (CPB) microlithography of a pattern, defined by a segmented reticle, onto a sensitive substrate by passing a charged-illumination beam through an illumination-optical system to a selected region on a reticle to form a patterned beam propagating downstream of the reticle, and passing the patterned beam through a projection-optical system to a corresponding region on the sensitive substrate, a method for reducing aberrations caused by space-charge effects, the method comprising:
scanning the illumination beam in a lateral illumination-beam-scanning direction across the selected region of the reticle during exposure of the reticle;
passing the illumination beam through a field-limiting diaphragm situated in the illumination-optical system, the field-limiting diaphragm comprising an aperture plate defining at least one aperture having a substantially annular profile or at least a portion of a substantially annular profile that shapes the illumination beam, so as to form the illumination beam into a hollow illumination beam having, as incident on the reticle, a substantially annular transverse profile or a portion of a substantially annular transverse profile; and
illuminating the selected region on the reticle with the hollow illumination beam.

18. The method of claim 17, wherein:
the field-limiting diaphragm defines at least one aperture having a chevron profile concentric with a beam-propagation axis of the illumination beam; and
the illumination beam is passed through the at least one aperture having a chevron profile.

19. The method of claim 18, wherein:
the field-limiting diaphragm defines two chevron-shaped apertures facing each other and that are concentric with the beam-propagation axis of the illumination beam; and
the illumination beam is passed through the two chevron-shaped apertures.

20. The method of claim 17, further comprising the step of scanning, using the deflector in the illumination-optical system, the illumination beam at a constant sweep velocity across the illuminated region.

21. The method of claim 17, further comprising the steps of:
mounting the reticle on a reticle stage situated downstream of the illumination-optical system and configured for moving the reticle relative to the illumination-optical system;
mounting the substrate on a substrate stage situated downstream of the projection-optical system and configured for moving the substrate relative to the projection-optical system; and
using the reticle stage and substrate stage, moving the reticle and substrate, respectively, in respective stage-scanning directions, that are substantially orthogonal to the illumination-beam-scanning direction, during exposure of the reticle pattern.

22. The method of claim 17, further comprising the step of providing the illumination beam with a distribution of beam density, immediately upstream of the reticle, that is constant over the region of the reticle illuminated by the illumination beam at any given instant in time.

23. The method of claim 17, further comprising the step of providing, using a dynamic compensator situated in the projection-optical system, a change to the patterned beam so as to compensate for aberrations of the image of the reticle pattern on the substrate surface.

24. The method of claim 23, further comprising the step of changing the compensation applied by the dynamic compensator to the patterned beam, according to scanning of the illumination beam on the reticle by the deflector.

25. The method of claim 17, further comprising the step of compensating for a change in profile of the illumination beam, as incident on the reticle, due to scanning of the illumination beam by the deflector.

26. The method of claim 25, further comprising the step of changing the compensation according to a change in scanning position of the illumination beam on the reticle as imparted by the deflector.

27. The method of claim 17, further comprising the step of providing the illumination beam, as incident on the reticle, with an aperture-angle distribution ranging between a preselected minimum angle α_{ret, min} and a preselected maximum angle α_{ret, max}.

28. The method of claim 27, wherein:
the charged particle beam is an electron beam; and
the minimum angle α_{ret, min} and the maximum angle α_{ret, max} each have a tolerance within a range of 1.5 to 3.0 mrad, and |α_{ret, max}−α_{ret, min}|≦0.75 mrad.

29. A process for manufacturing a microelectronic device, comprising a CPB microlithography process performed using a CPB microlithography apparatus as recited in claim 1.
